(19) United States
(12) Patent Application Publication
(10) Pub. No.: US 2015/0098786 A1
(43) Pub. Date: Apr. 9, 2015

(54) WORK TOOL POSITION SENSING ASSEMBLY

(71) Applicant: Caterpillar Inc., Peoria, IL (US)

(72) Inventor: Michael Subrt, Chillicothe, IL (US)

(73) Assignee: Caterpillar Inc., Peoria, IL (US)

(21) Appl. No.: 14/045,370

(22) Filed: Oct. 3, 2013

(51) Int. Cl. E02F 9/26; G01B 21/22; G01D 5/12; G01D 5/26; E02F 9/00; E02F 3/36

(52) U.S. Cl. CPC E02F 9/26; E02F 9/006; E02F 3/3677; G01D 5/12; G01D 5/26; G01B 21/22
USPC 414/697; 702/151

(57) ABSTRACT

A work tool position sensing assembly for an earth moving machine is disclosed. The earth moving machine has a pivotally movable work tool connected to the pivotally movable stick. The work tool and the stick are interconnected by a tilt linkage. Angular position of the work tool is determined by a work tool position sensing assembly. The work tool position sensing assembly includes a pivot pin, a first gear, a second gear and a rotatory position sensor. The pivot pin is configured to attach the stick with the tilt linkage and is permitted to rotate proportionally with the angular rotation of the work tool. The rotation of the pivot pin is transmitted to the rotatory position sensor via the first gear and the second gear. The rotatory position sensor is configured to measure the angular rotation of the pivot pin. The rotatory position sensor is disposed inside the body of the stick.

### TECHNICAL FIELD

The present disclosure relates to a work tool position sensing assembly to determine angular position of a work tool of an earth moving machine.

### BACKGROUND

Various types of earth moving machines and material loading vehicles are used on construction and mining sites to perform different operations. Examples of such operations may include excavation, demolition, mining, material handling and the like. These machines, such as wheel type loaders, include work tools capable of being moved through a number of positions during a work cycle. Such tools typically include a bucket, a fork, a grapple, a hydraulic hammer or other material handling apparatus. The typical work cycle associated with a bucket includes sequentially positioning the bucket and associated stick in a digging position for filling the bucket with material, a carrying position, a raised position, and a dumping position for removing material from the bucket.

In certain operations, such as during excavation, improper handling of the work tool may cause spilling of excavated material. The spilling of excavated material may lead to repetitive work and may result in lower efficiency of the machine. Hence, an angular position of the work tool has to be determined to keep the work tool in position such that the spilling of excavated material is prevented. There are several techniques known in the art to determine the angular position of the work tool. One such technique may use a sensor in relation to different components of the work tool to determine the angular position of the work tool. However, the sensors used to determine the angular position of the work tool are exposed to harsh environments because of the working conditions. The exposure leads to interruptions to the sensor because of deposition of dust and poor handling. Harsh environments can also damage the sensor and electrical assembly associated with the sensor.

### SUMMARY OF THE DISCLOSURE

The present disclosure provides a work tool position sensing assembly for an earth moving machine. The earth moving machine has a pivotally movable work tool connected to a pivotally movable stick. The work tool and the stick are interconnected by a tilt linkage. The work tool position sensing assembly includes a pivot pin, a first gear, a second gear, and a rotatory position sensor. The pivot pin is configured to attach the tilt linkage with the stick and rotate with the rotation of the work tool. The pivot pin is disposed perpendicular to the stick for pivotally mounting the tilt linkage. The first gear is rigidly mounted on the pivot pin. The first gear is configured to rotate with the pivot pin. The second gear is in a constant mesh with the first gear. The second gear rotates proportionally with the first gear. The rotatory position sensor is coupled to the second gear and is disposed inside the stick. The rotatory position sensor is configured to measure the rotation of the second gear.

In another embodiment a work tool position sensing assembly for a earth moving machine having a pivotally moveable work tool connected to a pivotally moveable stick, the work tool and the stick interconnected by a tilt linkage, the tilt linkage being pivotally mounted on a pivot pin disposed perpendicularly on the stick, the pivot pin configured to rotate with the movement of the tilt linkage is provided. The work tool position sensing assembly includes a first gear rigidly mounted on the pivot pin and configured to rotate with the rotation of the pivot pin. The work tool position sensing assembly further includes a second gear engaged with the first gear for rotation with the first gear. Moreover, the work tool position sensing assembly includes a rotatory position sensor coupled with the second gear and disposed inside the stick, wherein the rotatory position sensor is configured to measure the rotation of the second gear.

### BRIEF DESCRIPTION OF THE DRAWING

FIG. 1 illustrates a side view of an earth moving machine showing various components connected together to perform an operation; and

FIG. 2 illustrates a top view of a stick showing the arrangement of various components of a position sensing assembly to determine the angular rotation of a work tool.

### DETAILED DESCRIPTION OF THE DRAWINGS

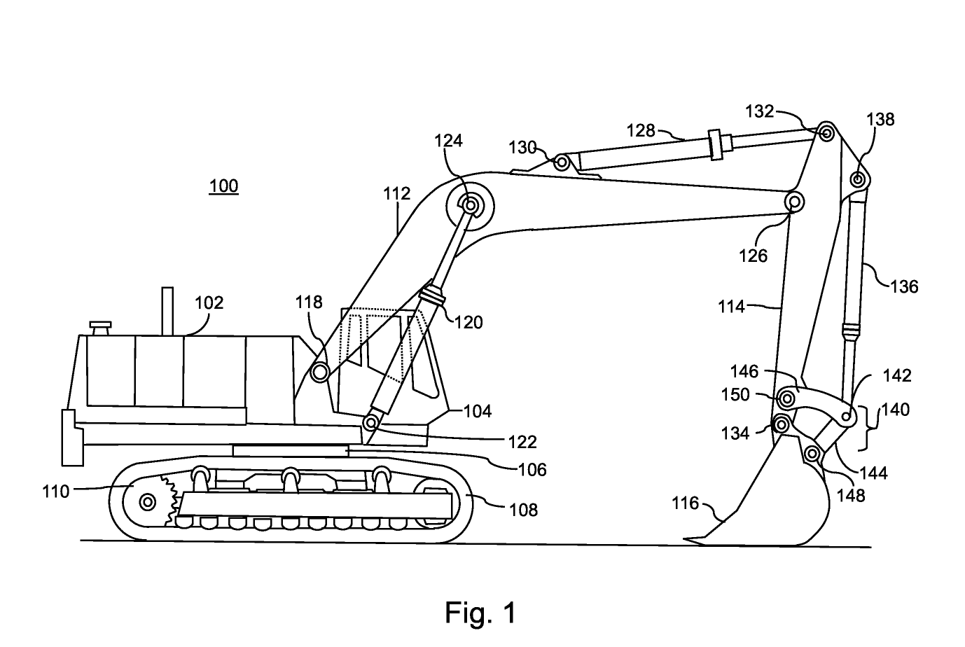

FIG. 1 is a side view of an earth moving machine 100 such as an excavator. Although the embodiments in the present disclosure are described with reference to the components of an excavator, it is understood that the earth moving machine 100 could be an excavator, a backhoe, and the like.

The earth moving machine 100 includes an upper structure, a lower structure and a working element. The upper structure includes a rotatably mounted body 102 and an operator cab 104. The operator cab 104 can be connected to the body 102 and houses one or more control devices for controlling the operations of the earth moving machine 100.

The lower structure comprises an undercarriage 106 supported by a pair of tracks 108 and a sprocket 110. The body 102 mentioned as a part of upper structure is rotatably mounted on the undercarriage 106.

The working element comprises a boom 112, a stick 114, a work tool 116 and a plurality of hydraulic cylinders. The boom 112 can be mounted at a pivot point 118 on a forward end of the body 102. The boom 112 can be moved vertically by expanding or retracting a boom hydraulic cylinder 120. A lower end of the boom hydraulic cylinder 120 can be pivoted to a forward end of the body 102 at a pivot point 122 and an upper end of the boom hydraulic cylinder 120 can be pivotally mounted on the boom 112 at a pivot point 124.

The stick 114 can be pivotally connected to a forward end of the boom 112 at a pivot point 126. A stick hydraulic cylinder 128 can have a first end mounted by pivot point 130 on the boom 112 and a second end mounted on an upper end of the stick 114 at a pivot point 132. Further, the work tool 116 can be pivotally mounted on the lower end of the stick 114 at a pivot point 134. A work tool hydraulic cylinder 136 has a first end pivotally connected to the upper end of the stick 114 at pivot point 138 and a second end pivotally connected to a tilt linkage 140 at pivot point 142. In an embodiment, the tilt linkage 140 can include two links, a first link 144 and a second link 146. The first link 144 and the second link 146 can be pivoted at the pivot point 142. Further, the first link 144 can be pivoted on the work tool 116 at the pivot point 148. The second link 146 can be pivoted on the stick 114 at the pivot point 150. Hence, the first link 144 and the second link 146 interconnect the stick 114 and the work tool 116 through the tilt linkage 140. It can be contemplated that the extension and retraction of the work tool hydraulic cylinder 136 can cause the work tool 116 to pivot about the pivot point 134 and also result in the movement of the second link 146 pivoted at the pivot point 150. It may be noted that the pivot point 150 can be located on the stick 114 substantially close to the pivot point 134. In an embodiment, the second link 146 can be pivoted at the pivot point 150 with a pivot pin (not shown in figure) retained inside a bore on the stick 114. Hence, the pivot point 150 enables a controllably and independently moveable connection of the work tool 116 to a multiplicity of desired positions.

Although the present disclosure describes the idea as used in a hydraulic excavator as shown in FIG. 1, it will be appreciated that the disclosed idea can be implemented in other machines like loaders, scrapers, graders, agricultural machines, and the like, without departing from the scope of the present disclosure.

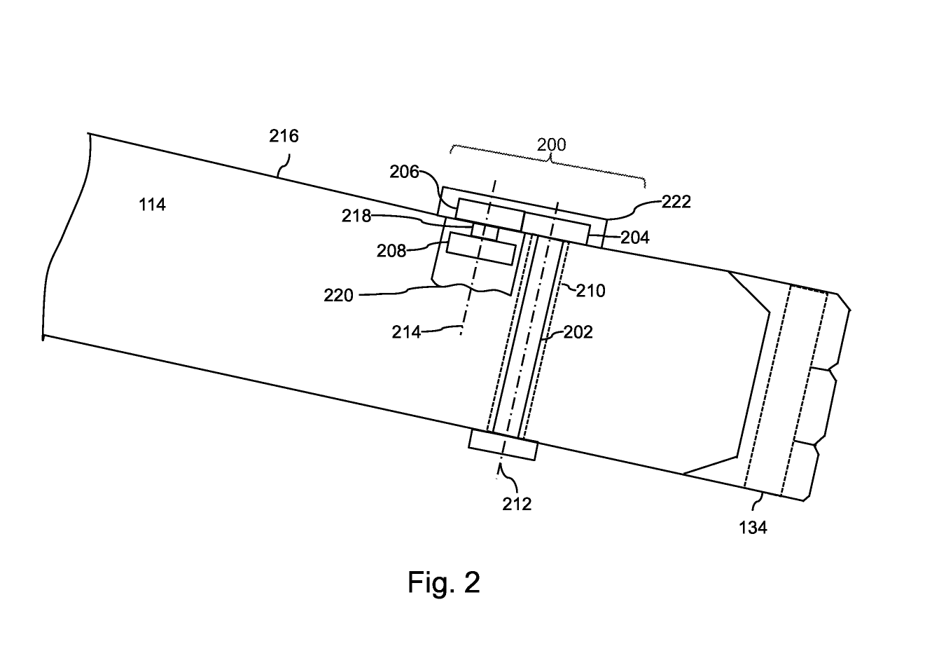

FIG. 2 illustrates a top view of the stick 114 showing arrangement of various components of a position sensing assembly 200. The assembly 200 can be described in conjunction with the pivot point 150 and other components described in FIG. 1. The assembly 200 can be mounted on the stick 114 at the pivot point 150. The assembly 200 includes a pivot pin 202, a first gear 204, a second gear 206 and a rotatory position sensor 208.

The pivot pin 202 can be configured to pivotally attach the stick 114 to the second link 146 of the tilt linkage 140. The pivot pin 202 can be disposed perpendicular to the stick 114, in a bore 210 on the stick 114. In other words, the pivot pin 202 can be disposed perpendicularly in the bore 210 of the stick 114 and pivotally mount the tilt linkage 140 thereby permitting a relative pivotal movement. In an embodiment, the stick 114 can be a box construction hollow frame body. The bore 210 can be drilled through the frame body of the stick 114 to house the pivot pin 202. The pivot pin 202 can be retained inside the bore 210 such that the pivot pin 202 can rotate with movement of the second link 146 of the tilt linkage 140. In other words, the rotation of the work tool 116 with respect to the stick 114 can induce a corresponding rotary motion in the pivot pin 202. The pivot pin 202 rotates about an angle corresponding to the angular rotation of the work tool 116 with respect to the stick 114. Hence, the angular rotation of the work tool 116 can be determined by measuring the angular rotation of the pivot pin 202.

The first gear 204 can be rigidly mounted on the pivot pin 202. As used herein, the term “rigidly” refers to a fixed connection between the pivot pin 202 and the first gear 204, such that the angle of rotation of the pivot pin 202 is same as the angle of rotation of the first gear 204. Examples of the fixed connection may be welded connection, adhesive connection, bolted connection, and the like. The first gear 204 rotates along with the pivot pin 202 about a longitudinal axis 212 of the pivot pin 202.

Further, the second gear 206 can be mounted on the stick 114 such that the second gear 206 can be in constant mesh with the first gear 204. In other words, the second gear 206 can be mounted such that the axis 214 of the second gear is parallel to the longitudinal axis 212. It may be noted that both the first gear 204 and the second gear 206 are mounted in a manner that the gears are disposed outside a frame body 216 of the stick 114. The first gear 204 and the second gear 206 are engaged such that the rotation of the first gear 204 can be transmitted to the second gear 206. In one embodiment the rotation of the second gear 206 can be proportional to the rotation of the first gear 204.

The second gear 206 can be further connected with an intermediate shaft 218. The intermediate shaft 218 can be mounted on a bore (not shown in Figure) on the stick 114, such that the intermediate shaft 218 acts a pivotal pin for the gear 206. Thus, the rotation of the second gear 206 can be translated into the rotation of the intermediate shaft 218. Hence to sum up, the rotation of the work tool 116 rotates the tilt linkage 140, which in turn rotates the pivot pin 202. The rotation of the pivot pin 202 can be transmitted through the first gear 204 and the second gear 206 into the rotation of the intermediate shaft 218.

The intermediate shaft 218 can be further connected to the rotatory position sensor 208 in a manner such that the rotation of the intermediate shaft 218 causes the rotation of the rotatory position sensor 208. Hence, the rotatory position sensor 208 can be coupled to the second gear 206 through the intermediate shaft 218. The rotatory position sensor 208 can be mounted on the intermediate shaft 218 of the second gear 206 such that the rotatory position sensor 208 rotates at an angle proportional to that of the second gear 206. The rotatory position sensor 208 can be disposed inside a cavity 220 of the frame body 216 of the stick 114. The rotatory position sensor 208 may be a magnetic sensor, an absolute optical encoder, an incremental encoder, and the like. However, it would be evident to a person with ordinary skill in the art that the type of sensor used does not affect the functionality of the assembly 200 disclosed herein.

Hence, the pivot pin 202 rotates at about the same angle as the work tool 116 rotates at, with respect to the stick 114. As the first gear 204 is rigidly mounted on the pivot pin 202, the first gear 204 rotates about an angle same as the pivot pin 202. The second gear 206 being in constant mesh with the first gear 204 rotates proportionally with the first gear 204. As the rotatory position sensor 208 is mounted on the intermediate shaft 218 of the second gear 206, the rotatory position sensor 208 is operable to sense and measure the angle of rotation of the second gear 206. As the angle of rotation of the second gear 206 corresponds to the angle of rotation of the work tool 116, the rotatory position sensor 208 determines the angular rotation of the work tool 116. The assembly 200 can be enclosed by a cover plate 222 which may be removably attached to the body 216 of the stick 114 by adhesion, fastening, bolting, or any method known to a person skilled in the art. The assembly 200 may also be used in conjunction with other components of the earth moving machine 100.

### INDUSTRIAL APPLICABILITY

Many types of machines known today have linkage members connected with the work tool 116 using pin joints to perform operations such as excavation, digging, mining, work handling and the like. Improper handling of the work tool 116 may cause spilling of the excavated material. In view of this, precise angular position of the work tool 116 has to be acquired. The angular position of the work tool 116 can be determined by measuring the angular rotation of the pivot pin 202 which is configured to attach the stick 114 to the tilt linkage 140. The tilt linkage 140 can be pivotally connected to the work tool 116. As the work tool hydraulic cylinder 136 is extended or retracted, the tilt linkage 140 rotates the pivot pin 202 clockwise or anti-clockwise respectively. The pivot pin 202 can be rigidly attached to the first gear 204. The first gear 204 can be in constant mesh with the second gear 206. The second gear 206 can be connected with the intermediate shaft 218. The intermediate shaft 218 can be in turn rigidly attached to the rotatory position sensor 208. The rotatory position sensor 208 can be used to measure the angular rotation of the second gear 206. Since, the angular rotation of the pivot pin 202 is transmitted to the rotatory position sensor 208 via the first gear 204 and the second gear 206 the rotatory position sensor 208 determines the angular rotation of the pivot pin 202. Hence, an angle of rotation of the work tool 116 of the earth moving machine 100 can be determined

Further, the rotatory position sensor 208 has to be protected from the harsh environment on the field for uninterrupted operation. The rotatory position sensor 208 can be disposed inside the body 216 of the stick 114 to protect the rotatory position sensor 208 from the harsh environment. The usage of the gears to transmit the angular rotation of the pivot pin 202 provides compact and cheaper mechanism for transmitting the angular rotation. The assembly 200 disclosed herein provides a reliable and cheaper mechanism to determine the angular rotation of the work tool 116 for any earth moving machine 100 in a compact space.

What is claimed is:

1. A work tool position sensing assembly for an earth moving machine having a pivotally moveable work tool connected to a pivotally moveable stick, the work tool and the stick interconnected by a tilt linkage comprising:
a pivot pin disposed perpendicular to the stick for pivotally mounting the tilt linkage to the stick, wherein the pivot pin rotates with the movement of the tilt linkage and the work tool;
a first gear rigidly mounted on the pivot pin and configured to rotate with the rotation of the pivot pin;
a second gear engaged with the first gear for rotation with the first gear; and
a rotatory position sensor coupled with the second gear and disposed inside the stick, wherein the rotatory position sensor is configured to measure the rotation of the second gear.

2. A work tool position sensing assembly for a earth moving machine having a pivotally moveable work tool connected to a pivotally moveable stick, the work tool and the stick interconnected by a tilt linkage, the tilt linkage being pivotally mounted on a pivot pin disposed perpendicularly on the stick, the pivot pin configured to rotate with the movement of the tilt linkage, comprising:
a first gear rigidly mounted on the pivot pin and configured to rotate with the rotation of the pivot pin;
a second gear engaged with the first gear for rotation with the first gear; and
a rotatory position sensor coupled with the second gear and disposed inside the stick, wherein the rotatory position sensor is configured to measure the rotation of the second gear.
